(19) United States
(12) Patent Application Publication
(10) Pub. No.: US 2025/0293528 A1
(43) Pub. Date: Sep. 18, 2025

(54) SYSTEM AND METHOD FOR SIMULTANEOUS CHARGING OF A PLURALITY OF BATTERIES

(71) Applicant: One Energetics, LLC, Brooklyn, NY (US)

(72) Inventors: Alan J. Kacperski, Willoughby, OH (US); Geoffrey S. Miller, Ardmore, PA (US)

(73) Assignee: One Energetics, LLC, Brooklyn, NY (US)

(21) Appl. No.: 19/078,759

(22) Filed: Mar. 13, 2025

Related U.S. Application Data
(60) Provisional application No. 63/566,630, filed on Mar. 18, 2024.

(51) Int. Cl. H02J 7/00; H01M 10/44; H02J 50/10

(52) U.S. Cl. CPC H02J 7/0013; H01M 10/441; H01M 10/443; H02J 7/0045; H02J 7/0048; H02J 7/00712; H02J 7/007194; H02J 50/10; H02J 2207/20

(57) ABSTRACT

The various embodiments herein provide a system and method for enabling simultaneous charging of multiple batteries. The embodiments also provide a system and method generating a magnetic field through a conductive strip placed around a plurality of battery banks to enable efficient and simultaneous charging of multiple batteries. The embodiments optimize the method in which battery banks are charged, rejuvenated and recycled. By utilizing a conductive strip to create a magnetic field, the system magnetically pulse charges batteries simultaneously, reducing temperature rise and enhancing overall efficiency. The system enables noninvasive battery recycling and optimized restoration, extending battery life and supporting environmental sustainability. Key benefits include faster charging times, reduced thermal risks and the ability to rejuvenate batteries previously considered at the end of their lifecycle.

### CROSS-REFERENCE TO RELATED APPLICATIONS

The embodiments herein claim the priority of the US Provisional Patent Application filed on Mar. 18, 2024, with the No. 63/566,630 and titled, “SYSTEM AND METHOD FOR SIMULTANEOUS CHARGING OF A PLURALITY OF BATTERIES”, the contents of which are incorporated herein by the way of reference.

### BACKGROUND

### Technical Field

The embodiments herein are generally related to the field of battery management and charging systems. The embodiments herein are particularly related to methodologies for charging and rejuvenating battery banks using magnetic impulse technologies that deliver magnetic pulse current (MPC). The embodiments are more particularly related to enhancing battery life, safety and efficiency through noninvasive battery capacity restoration processes in battery second life ecosystems.

### Description of the Related Art

The current state of battery charging technology, especially for high-capacity battery banks, relies heavily on conventional charging methods. These methods often deliver direct current (DC) as constant current-constant voltage (CCCV). While effective in replenishing battery power, CCCV continues to pose significant issues. One notable issue is the excessive heat generation during the charging process, which not only poses safety risks due to the potential for thermal runaway events including fires and explosions, but also accelerates overall battery degradation. This thermal stress contributes to various forms of battery wear, including lithium plating, sulfation and corrosion, ultimately reducing the battery's lifespan and efficiency.

Moreover, the environmental impact of current battery charging and disposal practices must be considered. As batteries reach the end of their usable life, they are often discarded, leading to increased electronic waste that can leach harmful chemicals into the soil and waterways. Although recycling programs exist, the process of breaking down and safely disposing of battery components is both costly and energy-intensive. Furthermore, conventional charging technologies do not sufficiently address the area of battery rejuvenation. Batteries that can be potentially be restored to a functional state are instead prematurely classified as waste.

In addition, current charging systems lack the capability to efficiently charge multiple batteries in a bank simultaneously without individual monitoring and management. This limitation is particularly problematic in applications requiring large battery arrays, such as in EVs or grid-scale energy storage, where uniform charging is essential for maintaining system performance and reliability. The cost and complexity of thermal management systems designed to mitigate the heat generated during charging further highlight the inefficiencies of existing charging technologies.

Hence, there exists a need for a novel approach to battery charging that significantly reduces heat generation, enhances safety and extends the battery's usable life through magnetic pulse charging. There also exists a need for a system and method for generating a magnetic field through a conductive strip placed around a plurality of battery banks to enable simultaneous, efficient charging of multiple batteries. There also exists a need for a system and method to not only mitigate the thermal risks associated with conventional charging, but also to offer a pathway to battery rejuvenation, noninvasive battery recycling and optimized battery restoration, thereby reducing the environmental impact of battery disposal.

The above-mentioned shortcomings, disadvantages and problems are addressed herein and which will be understood by reading and studying the following specification.

### OBJECTIVES OF THE EMBODIMENTS

The primary objective of the embodiments herein is to provide a system and method for enabling efficient and simultaneous charging of multiple batteries.

Another object of the embodiments herein is to provide a system and method generating a magnetic field through a conductive strip placed around a plurality of battery banks to enable efficient and simultaneous charging of multiple batteries.

Yet another object of the embodiments herein is to provide a novel battery charging system that minimizes temperature rise during charging.

Yet another object of the embodiments herein is to provide a system and method to rejuvenate batteries nearing the end of their lifecycle, restoring them to functional capacity.

Yet another object of the embodiments herein is to enable noninvasive battery recycling processes, enhancing environmental sustainability.

Yet another object of the embodiments herein is to significantly reduce the charging time for battery banks.

Yet another object of the embodiments herein is to provide higher safety standards by minimizing thermal risks during charging of batteries.

Yet another object of the embodiments herein is to enable simultaneous charging of multiple batteries without compromising their integrity.

Yet another object of the embodiments herein is to provide a resource-effective solution for battery management across a plurality of sectors.

These and other objects and advantages of the embodiments herein will become readily apparent from the following detailed description taken in conjunction with the accompanying drawings.

### SUMMARY

The various embodiments herein provide a system and method for enabling simultaneous charging of multiple batteries. The embodiments also provide a system and method generating a magnetic field through a conductive strip placed around a plurality of battery banks to enable simultaneous and efficient charging of multiple batteries.

According to one embodiment herein, an isolated magnetic impulse battery charger system is provided for efficient charging, rejuvenation and restoration of a plurality of battery banks. The system employs a conductive strip wrapped around the battery banks, pulsed with an electric current to create a magnetic field that charges all batteries simultaneously. The method of charging significantly lowers the temperature rise typically associated with charging, enhancing battery life and safety. By integrating the isolated current pulse charger system's principles, the embodiments further enable noninvasive battery recycling and restoration, offering an optimized approach to managing battery banks across diverse applications.

According to one embodiment herein, a method is provided for enabling simultaneous charging of multiple batteries. The method includes: identifying a battery bank for charging/rejuvenation and wrapping the conductive strip around it; linking the system to a power source, utilizing an AC/DC converter if necessary; activating the system to pulse electric current through the conductive strip, generating a magnetic field around the battery bank; allowing the magnetic field to induce a charging current in each battery within the bank, efficiently charging or rejuvenating them; continuously assessing the charge levels and temperatures of the batteries to ensure optimal and safe charging conditions; automatically ceasing the charging process once the desired charge level is achieved, and disconnecting the battery bank from the system; evaluating the batteries post-charging for improvements in capacity and performance and preparing them for noninvasive recycling or reintegration into use.

According to one embodiment herein, a system for simultaneous charging and rejuvenation of a plurality of batteries is provided. The system comprises: a conductive strip configured to be placed around a plurality of battery banks, wherein the conductive strip is capable of carrying an electric current to generate a magnetic field for inducing a charging current in the battery banks; an inductance generator operatively coupled to the conductive strip, wherein the inductance generator is configured to modulate the magnitude and frequency of the magnetic field induced in the conductive strip; a current pulsing mechanism operatively connected to the conductive strip, wherein the current pulsing mechanism is configured to generate controlled electric pulses that are applied to the conductive strip to regulate the charging profile; a magnetic field inducer in communication with the conductive strip, wherein the magnetic field inducer is configured to ensure uniform distribution of the induced magnetic field across the plurality of battery banks, thereby enabling simultaneous charging; a control unit communicatively linked to the inductance generator, the current pulsing mechanism, and the magnetic field inducer, wherein the control unit is configured to dynamically adjust the charging parameters based on real-time feedback from charge level and temperature sensors; and, a plurality of battery banks positioned within the magnetic field generated by the conductive strip, wherein the battery banks comprise multiple batteries arranged to receive induced charging currents.

According to one embodiment herein, the conductive strip is made of a high-conductivity material such as Copper, Iron, Silver and Aluminum alloys and is configured to form a closed-loop or helical arrangement around the battery banks to maximize magnetic flux penetration and uniformity.

According to one embodiment herein, the inductance generator is configured to vary the inductive coupling between the conductive strip and the battery banks by adjusting the frequency and amplitude of the generated magnetic field. The frequency is dynamically modulated to optimize charging efficiency based on the internal resistance and state-of-charge of the batteries.

According to one embodiment herein, the current pulsing mechanism further comprises: a magnetic impulse charger configured to generate current pulses with variable duty cycles and amplitudes; a switching circuit configured to regulate the application of the electric pulses to the conductive strip; and a feedback control loop that adjusts the pulse characteristics based on sensed battery parameters, wherein the controlled pulsing minimizes thermal buildup and mitigates the risk of overcharging or uneven current distribution. The magnetic impulse charger is at least one isolated or non-isolated type of magnetic impulse charger.

According to one embodiment herein, the magnetic field inducer further comprises: a flux-guiding core configured to optimize the spatial distribution of the magnetic field, ensuring uniform energy transfer to all batteries in the bank; and a magnetic field homogenization circuit configured to dynamically adjust field strength based on variations in battery capacity and charge acceptance characteristics.

According to one embodiment herein, the control unit comprises: a microcontroller unit (MCU) or a digital signal processor (DSP) configured to execute real-time charging processes; a sensor network including temperature sensors, voltage sensors and current sensors configured to continuously monitor the battery banks; and an adaptive control process that dynamically adjusts the charging profile by modifying pulse width, frequency and current amplitude to optimize charging efficiency and extend battery lifespan.

According to one embodiment herein, the battery banks comprise a plurality of batteries selected from any battery chemistry, including lithium-ion, lead-acid, nickel-metal hydride (NiMH) and solid-state batteries. Each battery bank is independently monitored for charge acceptance efficiency, internal resistance and thermal behavior to facilitate targeted rejuvenation, enhanced longevity and prolonged battery life.

According to one embodiment herein, a method for simultaneous charging and rejuvenation of a plurality of battery banks is provided. The method comprises: identifying a plurality of battery banks for charging and placing a conductive strip around the plurality of battery banks; linking the conductive strip to a power source via an inductance generator and a current pulsing mechanism; activating the current pulsing mechanism to apply controlled electric pulses to the conductive strip, generating a magnetic field around the plurality of battery banks; inducing a charging current in each battery within the plurality of battery banks via the generated magnetic field, thereby enabling simultaneous charging and rejuvenation; continuously monitoring the charge levels and temperature of the plurality of battery banks using a sensor network communicatively linked to a control unit configured to optimize charging efficiency; dynamically adjusting the pulse characteristics, frequency and amplitude of the applied current based on real-time feedback received by the control unit from the sensor network; automatically ceasing the charging process upon detecting that the desired charge level is achieved, as determined by the control unit; and, evaluating the plurality of battery banks post-charging for improvements in capacity and performance and preparing them for reintegration, rejuvenation or noninvasive recycling.

According to one embodiment herein, the step of identifying a plurality of battery banks and placing the conductive strip around them is performed by a positioning mechanism integrated with the control unit, the positioning mechanism ensuring optimal placement of the conductive strip to maximize magnetic field coupling and to minimize energy losses.

According to one embodiment herein, the step of linking the conductive strip to a power source includes dynamically selecting between an AC/DC converter within the control unit and a high-frequency inverter circuit based on the operational requirements of the plurality of battery banks.

According to one embodiment herein, the step of activating the current pulsing mechanism is executed via a programmable pulse generation unit within the current pulsing mechanism, wherein the programmable pulse generation unit varies the pulse duration, frequency and amplitude to achieve controlled and efficient energy transfer to the plurality of battery banks. The current pulsing mechanism comprises at least one isolated or non-isolated type of magnetic impulse charger.

According to one embodiment herein, the step of inducing a charging current in each battery within the plurality of battery banks is facilitated by the magnetic field inducer, which ensures uniform distribution of the generated magnetic field across the plurality of battery banks, thereby achieving simultaneous and uniform charging.

According to one embodiment herein, the step of continuously monitoring charge levels and temperature is performed by the sensor network, which comprises temperature sensors, voltage sensors and current sensors communicatively linked to the control unit. The control unit processes real-time data to dynamically adjust charging parameters.

According to one embodiment herein, the step of dynamically adjusting pulse characteristics includes employing a closed-loop feedback mechanism within the control unit, wherein the control unit refines the charging process by modifying the pulse width, frequency and amplitude based on real-time feedback from the sensor network.

According to one embodiment herein, the step of automatically ceasing the charging process includes implementing an intelligent termination process executed by the control unit, wherein the intelligent termination process determines when the battery voltage and current stabilization thresholds are met, preventing overcharging and ensuring maximum efficiency.

According to one embodiment herein, the step of evaluating the plurality of battery banks post-charging comprises conducting capacity restoration analysis within the control unit, wherein the control unit applies secondary rejuvenation cycles if the detected charge retention of a battery bank falls below a predefined threshold, thereby enhancing battery longevity.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a system for enabling simultaneous charging of multiple batteries, according to one embodiment herein.

FIG. 2 illustrates a method for enabling simultaneous charging of multiple batteries, according to one embodiment herein.

FIG. 3 illustrates an exemplary implementation of the system for simultaneous charging of multiple batteries, according to one embodiment herein.

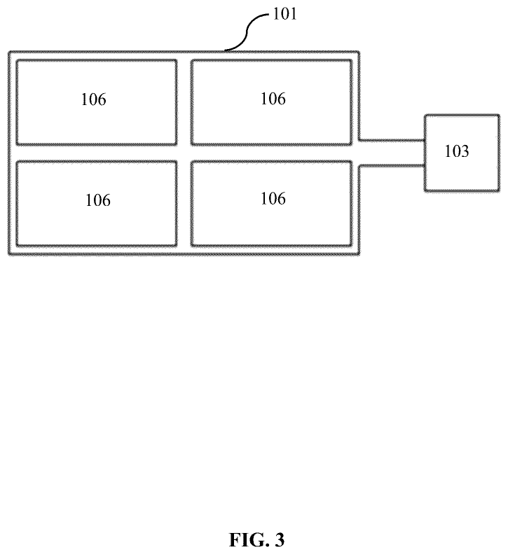

Although specific features of the embodiments herein are shown in some drawings and not in others. This is done for convenience only as each feature may be combined with any or all of the other features in accordance with the embodiments herein.

### DETAILED DESCRIPTION OF THE DRAWINGS

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for enabling simultaneous charging of multiple batteries. The embodiments also provide a system and method generating a magnetic field through a conductive strip placed around a plurality of battery banks to enable simultaneous and efficient charging of multiple batteries.

According to one embodiment herein, the system for enabling simultaneous charging of multiple batteries is provided as an isolated magnetic impulse battery charger, which comprises a plurality of functional modules, including, a Conductive Strip, an Inductance Generator, a Current Pulsing Mechanism, a Magnetic Field Inducer, a Control Unit and a plurality of Battery Banks. The Conductive Strip acts as the core component, facilitating the generation of a magnetic field when electrically pulsed. The Inductance Generator and Current Pulsing Mechanism enable the creation of magnetic impulses, while the Magnetic Field Inducer uniformly charges all batteries within the bank. The Control Unit oversees the charging process, optimizing efficiency and safety. The plurality of Battery Banks comprise multiple batteries that have either reached or are nearing the end of their original functional lifespan.

According to one embodiment herein, a method for charging and rejuvenating batteries includes connecting the battery bank to the charger; activating the conductive strip to generate magnetic impulses and monitoring the process until completion. This method not only charges but also rejuvenates batteries, enhancing their capacity and extending their useful life.

According to one embodiment herein, the Conductive Strip acts as the central element in creating the magnetic field necessary for the charger's operation. The conductive strip is made from a material with high electrical conductivity and is wrapped around the battery bank. When an electric current is pulsed through it, the conductive strip generates a magnetic field that permeates the batteries within its vicinity. This method of inducing a magnetic field directly addresses the need for an efficient, uniform charging mechanism that reduces the thermal stress traditionally associated with battery charging, thereby enhancing battery longevity and safety.

According to one embodiment herein, the Inductance Generator is integral to the charger's ability to create the magnetic impulses that charge the battery bank. By working in conjunction with the conductive strip, the inductance generator helps to regulate the magnitude and frequency of these impulses based on the charging requirements and the battery bank's current state. This regulation is crucial for optimizing the charging process, ensuring that batteries are charged effectively without being exposed to harmful overcharging or excessive heat generation, thus contributing to the system's overall safety and efficiency.

According to one embodiment herein, the Current Pulsing Mechanism controls the electric current's pulsing through the conductive strip, creating the magnetic impulses necessary for charging the batteries. This mechanism allows for precise control over the pulse characteristics, such as duration, frequency and amplitude, tailoring the charging process to the specific needs of the battery bank. By doing so, it plays a pivotal role in minimizing heat generation during charging, extending battery life and enabling the efficient rejuvenation of batteries that are nearing the end of their life cycle.

According to one embodiment herein, the Current Pulsing Mechanism further comprises an Isolated Magnetic Impulse Charger that is connected to the Conductive Strip. The Conductive Strip is connected to a charging coil in the Isolated Magnetic Impulse Charger and extends to the battery banks by wrapping around them and is connected back to the battery terminals through the Isolated Magnetic Impulse Charger While the wrapping of the coil around the battery banks keeps the magnetic field localized around the battery banks, the wired contact between the conductive strip and the battery terminals maintains the efficiency of the system.

According to one embodiment herein, the Magnetic Field Inducer is responsible for ensuring that the magnetic field generated by the conductive strip is uniformly distributed across all the batteries within the bank. This uniformity is critical for simultaneous charging of multiple batteries, ensuring that each battery receives an optimal charge without the risk of overcharging or uneven wear. The inducer's role is essential for maintaining the health and efficiency of large battery banks, making the system particularly beneficial for applications in electric vehicles, renewable energy storage and other high-capacity battery uses.

According to one embodiment herein, the Control Unit serves as the control mechanism of the charger, overseeing the entire charging process. It receives data from sensors monitoring the charging progress, including battery temperature and charge level and uses this information to make real-time adjustments to the charging parameters. It includes modifying the current pulses and managing the inductance generation to optimize charging efficiency and safety. The control unit's ability to adapt the charging process based on real-time feedback is crucial for preventing overheating, reducing wear on the batteries, and ensuring that the system operates within its optimal parameters.

According to one embodiment herein, the battery banks targeted for rejuvenation and recharging comprise multiple batteries that have either reached or are nearing the end of their original functional lifespan. These batteries, often found in electric vehicles, portable electronics and renewable energy storage systems, suffer from reduced capacity, efficiency and performance due to various forms of degradation such as lithium plating, sulfation and corrosion. The charging method provided by the system offers a noninvasive approach to not only recharge these batteries efficiently but also to rejuvenate and restore them to a state closer to their original capacity. This process extends the usable life of the batteries, significantly reducing waste and the environmental impact associated with the disposal and recycling of battery materials. By leveraging magnetic pulse charging, the system enables the battery banks to receive a uniform and efficient charge, minimizing heat generation and the associated risks, thereby addressing a critical need in battery technology for sustainable management and conservation of energy resources.

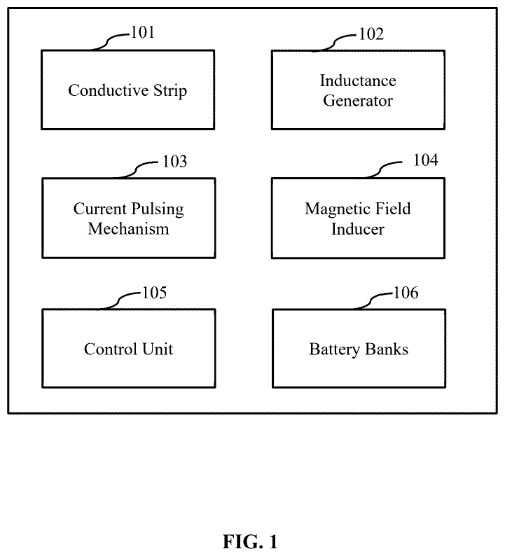

FIG. 1 illustrates a system for enabling simultaneous charging of multiple batteries. The system includes a Conductive Strip 101, an Inductance Generator 102, a Current Pulsing Mechanism 103, a Magnetic Field Inducer 104, a Control Unit 105 and a plurality of Battery Banks 106.

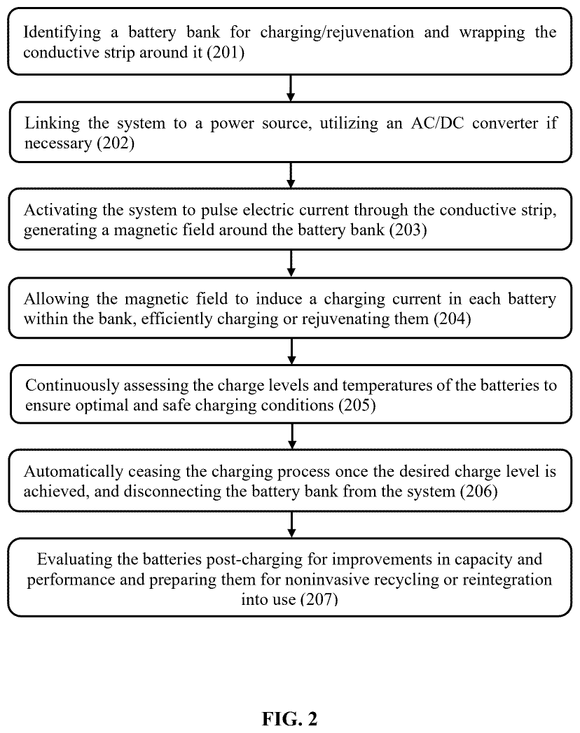

FIG. 2 illustrates a method for enabling simultaneous charging of multiple batteries. The method includes: identifying a battery bank for charging/rejuvenation and wrapping the conductive strip around it (201); linking the system to a power source, utilizing an AC/DC converter if necessary (202); activating the system to pulse electric current through the conductive strip, generating a magnetic field around the battery bank (203); allowing the magnetic field to induce a charging current in each battery within the bank, efficiently charging or rejuvenating them (204); continuously assessing the charge levels and temperatures of the batteries to ensure optimal and safe charging conditions (205); automatically ceasing the charging process once the desired charge level is achieved and disconnecting the battery bank from the system (206); and, evaluating the batteries post-charging for improvements in capacity and performance and preparing them for noninvasive recycling or reintegration into use (207).

The various embodiments herein provide a system and method for enabling simultaneous charging of multiple batteries. The embodiments also provide a system and method generating a magnetic field through a conductive strip placed around a plurality of battery banks to enable simultaneous and efficient charging of multiple batteries. The embodiments offer significant advantages over traditional charging methods, including lower operating temperatures, extended battery life, enhanced safety and increased charging efficiency. It enables noninvasive recycling and restoration of batteries, promoting environmental sustainability and reducing waste. The system's ability to charge multiple batteries simultaneously without degradation represents a major advancement in battery technology, benefiting sectors such as electric vehicles, consumer electronics and renewable energy storage.

Although the embodiments herein are described with various specific embodiments, it will be obvious for a person skilled in the art to practice the embodiments herein with modifications. The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

1. A system for simultaneous charging and rejuvenation of a plurality of batteries, the system comprising:
a conductive strip configured to be placed around a plurality of battery banks, wherein the conductive strip is capable of carrying an electric current to generate a magnetic field for inducing a charging current in the battery banks;
an inductance generator operatively coupled to the conductive strip, wherein the inductance generator is configured to modulate the magnitude and frequency of the magnetic field induced in the conductive strip;
a current pulsing mechanism operatively connected to the conductive strip, wherein the current pulsing mechanism is configured to generate controlled electric pulses that are applied to the conductive strip to regulate the charging profile;
a magnetic field inducer in communication with the conductive strip, wherein the magnetic field inducer is configured to ensure uniform distribution of the induced magnetic field across the plurality of battery banks, thereby enabling simultaneous charging;
a control unit communicatively linked to the inductance generator, the current pulsing mechanism, and the magnetic field inducer, wherein the control unit is configured to dynamically adjust the charging parameters based on real-time feedback from charge level and temperature sensors; and,
a plurality of battery banks positioned within the magnetic field generated by the conductive strip, wherein the battery banks comprise multiple batteries arranged to receive induced charging currents.

2. The system according to claim 1, wherein the conductive strip is made of a high-conductivity material such as Copper, Iron, Silver and Aluminum alloys and is configured to form a closed-loop or helical arrangement around the battery banks to maximize magnetic flux penetration and uniformity.

3. The system according to claim 1, wherein the inductance generator is configured to vary the inductive coupling between the conductive strip and the battery banks by adjusting the frequency and amplitude of the generated magnetic field, wherein the frequency is dynamically modulated to optimize charging efficiency based on the internal resistance and state-of-charge of the batteries.

4. The system according to claim 1, wherein the current pulsing mechanism further comprises: a magnetic impulse charger configured to generate current pulses with variable duty cycles and amplitudes; a switching circuit configured to regulate the application of the electric pulses to the conductive strip; and a feedback control loop that adjusts the pulse characteristics based on sensed battery parameters, wherein the controlled pulsing minimizes thermal buildup and mitigates the risk of overcharging or uneven current distribution, and wherein, the magnetic impulse charger is at least one of isolated or non-isolated type magnetic impulse charger.

5. The system according to claim 1, wherein the magnetic field inducer further comprises: a flux-guiding core configured to optimize the spatial distribution of the magnetic field, ensuring uniform energy transfer to all batteries in the bank; and a magnetic field homogenization circuit configured to dynamically adjust field strength based on variations in battery capacity and charge acceptance characteristics.

6. The system of claim 1, wherein the control unit comprises: a microcontroller unit (MCU) or a digital signal processor (DSP) configured to execute real-time charging processes; a sensor network including temperature sensors, voltage sensors and current sensors configured to continuously monitor the battery banks; and an adaptive control process that dynamically adjusts the charging profile by modifying pulse width, frequency and current amplitude to optimize charging efficiency and extend battery lifespan.

7. The system according to claim 1, wherein the battery banks comprise a plurality of batteries selected from any battery chemistry, including lithium-ion, lead-acid, nickel-metal hydride (NiMH) and solid-state batteries, and wherein each battery bank is independently monitored for charge acceptance efficiency, internal resistance and thermal behavior to facilitate targeted rejuvenation, enhanced longevity and prolonged battery life.

8. A method for simultaneous charging and rejuvenation of a plurality of battery banks, the method comprising:
identifying a plurality of battery banks for charging and placing a conductive strip around the plurality of battery banks;
linking the conductive strip to a power source via an inductance generator and a current pulsing mechanism;
activating the current pulsing mechanism to apply controlled electric pulses to the conductive strip, generating a magnetic field around the plurality of battery banks;
inducing a charging current in each battery within the plurality of battery banks via the generated magnetic field, thereby enabling simultaneous charging and rejuvenation;
continuously monitoring the charge levels and temperature of the plurality of battery banks using a sensor network communicatively linked to a control unit configured to optimize charging efficiency;
dynamically adjusting the pulse characteristics, frequency and amplitude of the applied current based on real-time feedback received by the control unit from the sensor network;
automatically ceasing the charging process upon detecting that the desired charge level is achieved, as determined by the control unit; and
evaluating the plurality of battery banks post-charging for improvements in capacity and performance and preparing them for reintegration, rejuvenation or noninvasive recycling.

9. The method according to claim 8, wherein the step of identifying a plurality of battery banks and placing the conductive strip around them is performed by a positioning mechanism integrated with the control unit, the positioning mechanism ensuring optimal placement of the conductive strip to maximize magnetic field coupling and to minimize energy losses.

10. The method according to claim 8, wherein the step of linking the conductive strip to a power source includes dynamically selecting between an AC/DC converter within the control unit and a high-frequency inverter circuit based on the operational requirements of the plurality of battery banks.

11. The method according to claim 8, wherein the step of activating the current pulsing mechanism is executed via a programmable pulse generation unit within the current pulsing mechanism, wherein the programmable pulse generation unit varies the pulse duration, frequency and amplitude to achieve controlled and efficient energy transfer to the plurality of battery banks, and wherein, the current pulsing mechanism comprises at least one of isolated or non-isolated type magnetic impulse charger.

12. The method according to claim 8, wherein the step of inducing a charging current in each battery within the plurality of battery banks is facilitated by the magnetic field inducer, which ensures uniform distribution of the generated magnetic field across the plurality of battery banks, thereby achieving simultaneous and uniform charging.

13. The method according to claim 8, wherein the step of continuously monitoring charge levels and temperature is performed by the sensor network, which comprises temperature sensors, voltage sensors and current sensors communicatively linked to the control unit, wherein the control unit processes real-time data to dynamically adjust charging parameters.

14. The method according to claim 8, wherein the step of dynamically adjusting pulse characteristics includes employing a closed-loop feedback mechanism within the control unit, wherein the control unit refines the charging process by modifying the pulse width, frequency, and amplitude based on real-time feedback from the sensor network.

15. The method according to claim 8, wherein the step of automatically ceasing the charging process includes implementing an intelligent termination process executed by the control unit, wherein the intelligent termination process determines when the battery voltage and current stabilization thresholds are met, preventing overcharging and ensuring maximum efficiency.

16. The method according to claim 8, wherein the step of evaluating the plurality of battery banks post-charging comprises conducting capacity restoration analysis within the control unit, wherein the control unit applies secondary rejuvenation cycles if the detected charge retention of a battery bank falls below a predefined threshold, thereby enhancing battery longevity.
